(19) United States
(12) Patent Application Publication
(10) Pub. No.: US 2013/0230763 A1
(43) Pub. Date: Sep. 5, 2013

(54) HOUSING FOR MERCURY-FREE BUTTON CELLS

(71) Applicants: Kemal Akca, Ellwangen (DE); Cornelia Csrenko, Rainau-Dalkingen (DE); Bernd Kreidler, Ellwangen (DE); Renate Freudenberger, Schwaikheim (DE)

(72) Inventors: Kemal Akca, Ellwangen (DE); Cornelia Csrenko, Rainau-Dalkingen (DE); Bernd Kreidler, Ellwangen (DE); Renate Freudenberger, Schwaikheim (DE)

(73) Assignee: Varta Microbattery GmbH, Ellwangen (DE)

(21) Appl. No.: 13/885,528

(22) PCT Filed: Nov. 22, 2011
(86) PCT No.: PCT/EP11/70635

§ 371 Date: May 15, 2013

(30) Foreign Application Priority Data
Nov. 25, 2010 (DE) 102010062001.7

(51) Int. Cl. H01M 2/02

(52) U.S. Cl. CPC H01M 2/0222
USPC 429/164; 148/532

(57) ABSTRACT

A method of producing a bowl-shaped housing half-part provided with a copper alloy interiorly of the housing of a mercury-free button cell includes (1) providing a clad material with a layer of nickel, a layer of copper and an intermediate layer of steel or high-grade steel, which is provided on a copper side with an additional coating including at least one metal selected from the group consisting of tin, zinc, indium and bismuth, (2) shaping a bowl-shaped housing half-part made of the clad material, wherein the layer of nickel forms an outside portion and the additional coating forms an inside portion of the bowl-shaped housing half-part, and (3) heat treating the housing half-part at a temperature where the at least one metal selected from the group consisting of tin, zinc, indium and bismuth is alloyed with the copper of the copper layer.

### TECHNICAL FIELD

This disclosure relates to a method of producing a bowl-shaped housing half-part, provided with a copper alloy on the inside, for the housing of a mercury-free button cell as well as housing half-parts produced according to the method and button cells having such housing half-parts.

### BACKGROUND

Usually, button cells comprise a housing of two housing half-parts, a cell cup usually configured in the shape of a bowl and a cell lid frequently also configured in the shape of a bowl. The parts can be produced from nickel-plated deep-drawn metal sheets as punch-drawn parts, for example. However, it is more common to use a clad material having a layer of nickel, a layer of copper and an intermediate layer of steel or stainless steel (so-called “tri-metal”) as housing material. Housing half-parts made of tri-metal are known from JP 61061364 A1, for example. A plastic ring arranged between the housing half-parts generally serves simultaneously as a sealing and insulator which ring separates the housing half-parts spatially and electrically from one another. Commonly, the cell cup of a button cell forms the positive pole and the cell lid the negative pole. The liquid-tight closure of such cells is mostly effected by crimping the edge of the cell cup.

Button cells frequently contain a paste or a gel made of zinc powder as a negative electrode. In that case, for example, gas diffusion electrodes (for zinc/air cells) or alternatively, e.g., manganese oxide or silver oxide can be used as positive counter electrodes.

Generally, an alkaline electrolyte, in particular concentrated aqueous potassium hydroxide, is used as an electrolyte in the aforementioned electrochemical systems. The presence of an alkaline electrolyte provides both advantages and disadvantages. A particular disadvantage is that in an alkaline environment, zinc can react with water very easily and form hydrogen. The cell can irreversibly be damaged as a consequence of the formation of hydrogen. Until today, the reaction of zinc and water in alkaline zinc cells has been regulated by adding mercury. However, due to toxicity and harm to the environment of mercury, that procedure is no longer an option for the future.

Mercury-free button cells where the inside of the cell lid is coated with a coating of a copper-tin alloy, a copper-zinc alloy or a copper-indium alloy to increase the hydrogen over-potential and keep the formation of hydrogen on an acceptable level even in the absence of mercury are known. However, the aforementioned alloys have low ductility so that production of deep-drawn lids is not possible without breaking the alloy coating.

### SUMMARY

We provide a method of producing a bowl-shaped housing half-part provided with a copper alloy interiorly of the housing of a mercury-free button cell including (1) providing a clad material with a layer of nickel, a layer of copper and an intermediate layer of steel or high-grade steel, which is provided on a copper side with an additional coating including at least one metal selected from the group consisting of tin, zinc, indium and bismuth, (2) shaping a bowl-shaped housing half-part made of the clad material, wherein the layer of nickel forms an outside portion and the additional coating forms an inside portion of the bowl-shaped housing half-part, and (3) heat treating the housing half-part at a temperature where the at least one metal selected from the group consisting of tin, zinc, indium and bismuth is alloyed with the copper of the copper layer.

We also provide a bowl-shaped housing half-part of a housing of a mercury-free button cell, composed of a clad material including a layer of nickel, a layer of steel and a layer including copper alloyed with at least one metal selected from the group consisting of tin, zinc, indium and bismuth, wherein the layer of nickel forms an outside portion and the layer with the copper alloy forms an inside portion of the bowl-shaped housing half-part, and wherein within the layer forming the inside portion of the bowl-shaped housing half-part, the concentration of copper decreases as a distance to the layer of steel increases and the concentration of the at least one element selected from the group consisting of tin, zinc, indium and bismuth increases in a same direction.

### BRIEF DESCRIPTION OF THE DRAWINGS

FIG. 1a schematically shows a cross-section of an example of our button cells.

FIG. 1b is an enlarged detail view of the button cell shown in FIG. 1a.

### DETAILED DESCRIPTION

Our method produces a bowl-shaped housing half-part provided with a copper alloy on the inside for the housing of a mercury-free (Hg-free) button cell. Generally, it comprises the following steps:

(1) In one step, a clad material is provided which comprises a layer of nickel, a layer of copper and an intermediate layer of steel or high-grade steel. The clad material is provided on the copper side with an additional coating of one of the metals tin, zinc, indium, bismuth or an alloy of the metals. Preferably, the additional coating is plated onto the layer of copper.

Plating refers to a procedure in metal processing where a metal is covered by another, in many cases a more precious metal. In the case of the clad material a layer of steel is covered by nickel and copper. Here, an inseparable bond should be formed between the metals. A variety of techniques may be used for this purpose such as rolling-on or welding-on of metal foils or electrochemical deposition of metallic precipitations. The latter is referred to as electroplating.

Preferably, the above mentioned tri-metal is used as a clad material. Tri-metal is a clad metal specifically developed for the housings of button cells. A thin foil of low carbon steel or corrosion resistant, stainless steel is generally used as a carrier. The thickness of the clad material is preferably 0.05 μm to 0.25 μm. In this case, the nickel layer generally accounts for 1% to 15% of the thickness of the clad material and the copper layer 5% to 30%. Correspondingly, the proportion of the steel foil in the thickness of the clad material is 55% to 94%.

Naturally, there is also the aforementioned coating made of any of the metals tin, zinc, indium, bismuth or an alloy of the metals. The coating is preferably applied to the copper side of the clad material by an electro-chemical procedure, that is to say by electroplating. Preferably, the thickness is 0.5 μm to 2 μm on average.

(2) The clad material provided according to (1) and coated on the copper side is preferably present in the form of an endless strip material. In the second step, a bowl-shaped housing half-part is formed of the clad material, wherein the layer of nickel forms the outside and the additional coating of any of the metals tin, zinc, indium, bismuth or an alloy of the metals forms the inside of the bowl-shaped housing half-part. Preferably, the bowl-shaped housing half-part is formed by a deep-drawing or punch-out process.
(3) As an additional step, the method comprises heat treatment of the housing half-part formed according to (2). The treatment is effected at a temperature where the additional coating made of any of the metals tin, zinc, indium, bismuth or an alloy of the metals is alloyed with the copper of the layer of copper.

Preferably, the heat treatment is effected at a temperature of at least 100° C. Particularly preferably, the minimum temperature the heat treatment is performed at is 200° C. The heat treatment is particularly preferably effected at a temperature of 200° C. to 400° C. At those temperatures, the metals tin, zinc, indium and/or bismuth can diffuse into the layer of copper, correspondingly copper alloys of the corresponding metals are forming. Since the copper alloys develop not earlier than after formation of the bowl-shaped housing half-part, their low ductility has no negative influence.

During diffusion of the aforementioned metals into the copper layer of the clad material, the boundaries between the copper layer and the described additional coating become blurred. In that process, the copper layer and the described additional coating merge into a new coating or layer.

However, preferably, the new layer or coating does not have a constant, uniform composition. Instead, during the aforementioned diffusing process, concentration gradients can form depending on the parameters selected for the heat treatment (in particular the parameters “temperature” and “time”). Such gradients can be detected by suitable analysis of the heat-treated housing half-parts.

Diffusion of the metals tin, zinc, indium and bismuth into the copper layer to a note-worthy extent starts but as from the aforementioned minimum temperature of 100° C., preferably as from 200° C. The diffusion kinetics are inhibited too strongly below that temperature.

Preferably, heat treatment is effected for a time period of 1 hour to 10 hours.

With our method, bowl-shaped housing half-parts can be produced which are composed of a clad material comprising a layer of nickel, a layer of steel or high-grade steel, and a layer comprising copper alloyed with at least one metal from the group consisting of tin, zinc, indium and bismuth, wherein the layer of nickel forms the outside of the bowl-shaped housing half-parts and the layer with the copper alloy forms the inside of the bowl-shaped housing half-parts. Such housing half-parts are likewise disclosed.

As already mentioned, preferably, the elements zinc, tin, indium and/or bismuth are not found in the same concentration all over within the layer forming the inside. Correspondingly, the housing half-parts are particularly characterized in that within the layer forming the inside, the concentration of copper decreases as the distance to the layer of steel increases and the concentration of the at least one element from the group consisting of zinc, tin, indium and bismuth increases in the same direction.

In other words, the copper is enriched within the layer including the copper alloy towards the layer of steel and depleted towards the bowl interior. In this case, the term “enriched” means that the local content of copper in the vicinity of the steel layer is greater than the average content of copper in the layer, while the term “depleted” means that the local content of copper towards the bowl interior is lower than the average content of copper in the layer. The average content of copper can be determined from the weight ratio of the copper proportion in the layer in relation to the sum of all proportions of the layer multiplied by the factor 100.

Preferably, the bowl-shaped housing half-part is the cell lid of a button cell.

Our button cell comprises a housing with such a housing half-part, in particular such a cell lid. Furthermore, the housing also comprises a second housing half-part corresponding to the housing half-part which preferably is a cell cup.

Preferably, the button cell has a zinc-containing anode, in particular a zinc/air button cell. In this case, the zinc-containing anode is in particular arranged within the bowl-shaped housing half-part.

Further features arise from the following description of the drawings by which our housings and methods are once again explained in more detail. It is explicitly noted that all facultative aspects of the method and other subject matter described herein can in each case be realized on their own or in a combination with one or multiple of the further described features in an example. The subsequently described, preferred examples merely serve for explanation and for a better understanding and are in no way to be understood as limiting.

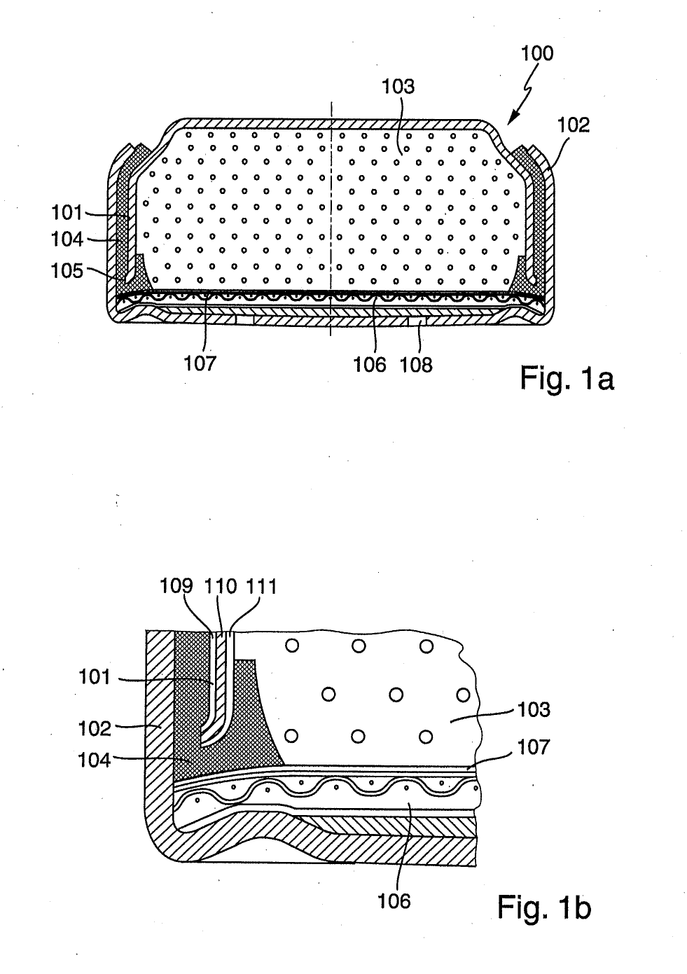

FIG. 1a shows a cross-sectional view of an example of a button cell 100. The cell comprises a cell lid 101 configured as a bowl-shaped housing half-part and produced according to the method described above. Furthermore, it comprises a likewise bowl-shaped cell cup 102 as a housing half-part corresponding to the cell lid 101. Together, the latter form the housing of the button cell 100. In the cell lid 101, a zinc paste 103 is arranged as negative active material. The material is free of mercury. A sealing 104 insulates the cell lid 101 and the cell cup 102 against one another and simultaneously seals the housing towards the exterior. It encloses the cutting edge 105 of the cell lid 101. In the bottom region of the cell cup 102, a gas diffusion electrode 106 is arranged. The electrode is separated from the zinc paste 103 by a separator 107. The bottom of the cell cup 102 comprises air inlet openings 108. Correspondingly, the button cell shown is a zinc/air button cell.

FIG. 1b shows an enlarged detail of the button cell 100 shown in FIG. 1a. Shown in detail are the cell cup 102 and the cell lid 101 as well as the sealing 104, the zinc paste 103, the gas diffusion electrode 106 and the separator 107. The cell lid 101 is made of a clad material comprising a layer of nickel 109, a layer of steel 110 and a layer 111 comprising copper and a copper-tin alloy. The individual layers are only shown in the enlarged illustration.

The layer 111 comprising copper and the copper-tin alloy forms the inside of the cell lid 101 and is in direct contact to the zinc paste 103. The layer 109 of nickel forms the outside of the cell lid.

The cell lid 101 was produced from a tri-metal provided with an additional coating of tin on the copper side. After punching the cell-lid 101 out of the material, the lid was heated for more than two hours to a temperature of about 200° C. During that procedure, the layer 111 comprising copper and the copper-tin alloy was formed of the copper side of the tri-metal and the additional layer of tin arranged thereon. A concentration gradient formed within the developing (common) layer 111 by diffusion. It was found that within the layer 111, copper was enriched towards the layer of steel. In contrast, the concentration of tin increased towards the bowl interior. Directly at the boundary between the layer 110 and the layer 111, even un-alloyed copper could be found. This also explains the use of the term layer 111 “comprising copper and of a copper-tin alloy.” The tin coating on the copper side of the tri-metal had a thickness of 0.2 μm to 5 μm prior to the heat treatment. The tin coating had been deposited on the tri-metal by an electrochemical procedure.

1. A method of producing a bowl-shaped housing half-part provided with a copper alloy interiorly of the housing of a mercury-free button cell, comprising:
(1) providing a clad material with a layer of nickel, a layer of copper and an intermediate layer of steel or high-grade steel, which is provided on a copper side with an additional coating comprising at least one metal selected from the group consisting of tin, zinc, indium and bismuth;
(2) shaping a bowl-shaped housing half-part made of the clad material, wherein the layer of nickel forms an outside portion and the additional coating forms an inside portion of the bowl-shaped housing half-part; and
(3) heat treating the housing half-part at a temperature where the at least one metal selected from the group consisting of tin, zinc, indium and bismuth is alloyed with the copper of the copper layer.

2. The method according to claim 1, wherein the heat treatment is effected at a temperature of at least 100° C.

3. The method according to claim 1, wherein the heat treatment is effected for a time period of 1 hour to 10 hours.

4. A bowl-shaped housing half-part for a housing of a mercury-free button cell, composed of a clad material comprising a layer of nickel, a layer of steel and a layer comprising copper alloyed with at least one metal selected from the group consisting of tin, zinc, indium, and bismuth, wherein the layer of nickel forms an outside portion and the layer with the copper alloy forms an inside portion of the bowl-shaped housing half-part, and wherein within the layer forming the inside portion of the bowl-shaped housing half-part, the concentration of copper decreases as a distance to the layer of steel increases and the concentration of the at least one element selected from the group consisting of tin, zinc, indium and bismuth increases in a same direction.

5. A button cell with a housing comprising a housing half-part according to claim 4.

6. The method according to claim 1, wherein the heat treatment is effected at a temperature of 200° C. to 400° C.

7. The method according to claim 2, wherein the heat treatment is effected for a time period of 1 hour to 10 hours.
